(19) United States
(12) Patent Application Publication
(10) Pub. No.: US 2017/0060112 A1
(43) Pub. Date: Mar. 2, 2017

(54) CONTROL PROGRAM FOR ACCESSING BROWSER DATA AND FOR CONTROLLING APPLIANCE

(71) Applicant: Katrina Danielle PIRNER, Thornhill (CA)

(72) Inventor: Thomas PIRNER, Minden (CA)

(21) Appl. No.: 14/833,413

(22) Filed: Aug. 24, 2015

(51) Int. Cl. G05B 19/042; H04L 29/08

(52) U.S. Cl. CPC G05B 19/042; H04L 67/025; G05B 2219/23298

(57) ABSTRACT

A localhost computer is network connectable with a website-hosting server, and is for use with an appliance. The localhost computer includes a localhost processor assembly and a non-transitory processor-readable localhost memory tangibly embodying a browser-assigned storage section, a browser application, and a control program. The browser application is configured to urge the localhost processor assembly to (A) access the browser data, and (B) not access contents of a remainder of the non-transitory processor-readable localhost memory beyond the browser data. The control program is configured to urge the localhost processor assembly to: (A) access the browser data stored in the browser-assigned storage section, and (B) control the appliance, in which a type of control to be imposed upon the appliance depends on the contents of the browser data that was accessed.

### TECHNICAL FIELD

This document relates to the technical field of (and is not limited to) a control program for accessing browser data stored in a browser-assigned storage section, and for controlling an appliance (and method therefor).

### BACKGROUND

The Internet is a global network connecting millions of computers. More than 190 countries are linked into exchanges of data, news and opinions.

The World Wide Web is an information system on the Internet that allows documents to be connected to other documents by hypertext links, enabling the user to search for information by moving from one document to another.

A localhost computer (in a computer networking system) is a hostname that means this computer.

A web browser (also referred to as a browser) is a software application that may be operated on a localhost computer. The web browser is configured to retrieve, present and/or traverse information resources on the World Wide Web. An information resource is identified by a Uniform Resource Identifier (URI/URL). The information resource may include a web page, an image, a video or other piece of content. Examples of the web browser include the CHROME (TRADEMARK) browser manufactured by GOOGLE and the INTERNET EXPLORER (TRADEMARK) browser manufactured by MICROSOFT or the SAFARI browser manufactured by APPLE, etc. These organizations, some of the largest in the world, have applied significant development resources to enhance and/or extend the functionality of their web browsers. Web browsers have evolved from a simple HTML server filed webpage presentation to a very complex software environment. HTML stands for Hypertext Markup Language, and HTML is a standardized system for tagging text files to achieve font, color, graphic, and hyperlink effects on the pages of the World Wide Web. This includes extensions, plug-ins and rich programming languages such as JAVASCRIPT (TRADEMARK) code, the PHP code (PHP is a server-side scripting language designed for web development), and others, which create an extremely rich set of software tools. The resulting powerful browser environment may be used by web designers to build very complex operational and multimedia web pages for clients.

### SUMMARY

It will be appreciated that there exists a need to mitigate (at least in part) at least one problem associated with the operation of existing web browsers (also called the existing technology). After much study of the known systems and methods with experimentation, an understanding of the problem and its solution has been identified and is articulated as follows:

A localhost is also called a client localhost, a computer system operating the web browser and/or a localhost computer (etc.) that includes the software and hardware environment of the localhost. The localhost is configured to interact with an appliance. Examples of the appliance may include a file (computer accessible file) that is tangibly stored in computer memory, executable software tangibly stored in computer memory and/or a hardware device operatively coupled to the localhost computer (and any equivalent thereof). The operation of the appliance is interactive with the operation of the localhost.

For security purposes, to protect the operation of the localhost, operation of the web browser is completely restricted from directly interfacing with the appliance of the localhost. This security arrangement is for good reason as otherwise a software hacker (also called a bad actor) could use (manipulate) the web browser in such a way that the hacker may gain control over the appliance of the localhost, and use this activity as a base of attack for destructive or nefarious purposes (e.g. to obtain access to bank records, credit card information, etc.).

By placing strong restrictions on the operation of a web browser, the functionality of the web browser is contained in a sandbox (that is, a segregated area) separate from the other areas (such as, portions of the computer memory) of the localhost. The sandbox (limitation of restricted browser operations) cannot be breached by the web browser thereby limiting the browser functionality to never directly interfacing or interacting (e.g. performing computing operations, such as a read operation, a write operation, a modify operation, a delete operation, a copy operation, a command operation, etc., and any equivalent thereof) with the appliance of the localhost.

The restrictions placed on the operation of the web browser through sandbox containment (the restrictions placed on the operation of the web browser may be called, sandboxing) is that friendly, functional browser programming or client localhost applications (requiring a browser-to-appliance interface) cannot be developed without very complex indirect methods (or complex programmed coding), high overhead and resource utilization. For example, a local browser-to-localhost connection may be established by running (operating) a web server (also called, localhost software) on the localhost computer and having the web browser interact with that localhost web server process as if that localhost web server process were another internet site even though the web server is physically located on the same localhost computer. While this arrangement facilitates a connection between the web browser and the localhost computer, the process is complex and may require significant operational resources to achieve the simple function of setting up a communication path from the web browser to the localhost computer. For limited resource localhost applications (software) requiring a browser communication path (e.g., for data, messages, commands, etc.) and executing on a relatively small processor or a tablet, a smartphone or the relatively newer microcomputers, the complexity and resource overhead of simultaneously executing a web server may be prohibitive.

An example of a problem associated with the existing technology is a WebRTC video chat session that operates between (A) a handicapped user (using a localhost computer requiring the automated assistance of a control program), and (B) a capable user using a client computer). The existing arrangement requires the handicapped user to have a degree of computer knowledge and skills in order to cope with the implementing and maintaining the video chat session, while the capable user waits for the handicapped user to manage their side of the video chat session (resulting in frustration for both users).

To mitigate, at least in part, at least one problem (as identified above) associated with the existing technology, there is provided (in accordance with a major embodiment) a localhost computer. The localhost computer is for use with a network that is network connectable with a website-hosting server. The localhost computer is also for use with an appliance configured to be interactive with the website-hosting server. The localhost computer includes a localhost processor assembly that is network connectable with the network. A non-transitory processor-readable localhost memory is configured to operatively couple to the localhost processor assembly. The non-transitory processor-readable localhost memory includes a localhost non-volatile storage tangibly embodying a browser-assigned storage section (the browser-assigned storage section is configured to tangibly embody browser data associated with a browser application). The non-transitory processor-readable localhost memory also includes a localhost volatile memory tangibly embodying the browser application configured to urge the localhost processor assembly to (A) access (either directly or indirectly) the browser data tangibly embodied in the browser-assigned storage section, and (B) not access contents of a remainder of the localhost non-volatile storage beyond the browser-assigned storage section. The localhost volatile memory also tangibly embodies a control program including processor-executable instructions configured to urge the localhost processor assembly to: (A) access (either directly or indirectly) the browser data stored in the browser-assigned storage section, and (B) control (either directly or indirectly) the appliance, in which a type of control to be imposed (either directly or indirectly) upon the appliance, by the localhost processor assembly, depends on the contents of the browser data that was accessed (either directly or indirectly) from the browser-assigned storage section.

To mitigate, at least in part, at least one problem associated with the existing technology, there is provided (in accordance with a major aspect) a non-transitory computer-readable medium, such as a CD disk, a portable flash, a micro SD card, etc. (as described in the detailed description and the claims).

To mitigate, at least in part, at least one problem associated with the existing technology, there is provided (in accordance with a major aspect) a computer-implemented method (as described in the detailed description and the claims).

To mitigate, at least in part, at least one problem associated with the existing technology, there is provided (in accordance with a major aspect) a computer-implemented method of operating a control program (also called a non-browser application) being executable on a localhost computer. The localhost computer is for use with a network being network connectable with a website-hosting server. The localhost computer is also for use with an appliance configured to be interactive with the website-hosting server. The computer-implemented method is to be executable by the localhost computer, including urging the localhost computer to perform operations, including: (A) accessing browser data, associated with a browser application, tangibly embodied in a browser-assigned storage section of a non-transitory processor-readable localhost storage of a non-transitory processor-readable localhost memory, and the non-transitory processor-readable localhost memory being configured to operatively couple to a localhost processor assembly of the localhost computer, and the localhost processor assembly being network connectable with the network, and the non-transitory processor-readable localhost memory including a non-transitory localhost volatile memory tangibly embodying the browser application being configured to urge the localhost processor assembly to (A) access the browser data tangibly embodied in the browser-assigned storage section, and (B) not access contents of a remainder of the non-transitory processor-readable localhost storage beyond the browser-assigned storage section, and (B) controlling the appliance, in which a type of control to be imposed upon the appliance, by the localhost processor assembly, depends on the contents of the browser data that was accessed from the browser-assigned storage section.

Other aspects are identified in the claims.

Other aspects and features of the non-limiting embodiments may now become apparent to those skilled in the art upon review of the following detailed description of the non-limiting embodiments with the accompanying drawings.

### BRIEF DESCRIPTION OF THE DRAWINGS

The non-limiting embodiments may be more fully appreciated by reference to the following detailed description of the non-limiting embodiments when taken in conjunction with the accompanying drawings, in which:

FIG. 1 (SHEET 1 of 5 SHEETS) depicts a schematic view of an embodiment of a localhost computer, a website-hosting server, a remote client computer and a network;

FIG. 2A and FIG. 2B (SHEET 2 and 3 of 5 SHEETS) depict schematic views of embodiments of the localhost computer of FIG. 1, in which the localhost computer is provided with a control program;

FIG. 3 (SHEET 4 of 5 SHEETS) depicts a schematic view of an embodiment of the localhost computer of FIG. 1, in which the localhost computer is provided with a control program; and

FIG. 4 (SHEET 5 of 5 SHEETS) depicts a schematic view of an embodiment of a flow chart for the control program of any one of FIG. 2A, FIG. 2B and FIG. 3.

The drawings are not necessarily to scale and may be illustrated by phantom lines, diagrammatic representations and fragmentary views. In certain instances, details unnecessary for an understanding of the embodiments (and/or details that render other details difficult to perceive) may have been omitted.

Corresponding reference characters indicate corresponding components throughout the several figures of the drawings. Elements in the several figures are illustrated for simplicity and clarity and have not been drawn to scale. The dimensions of some of the elements in the figures may be emphasized relative to other elements for facilitating an understanding of the various disclosed embodiments. In addition, common, but well-understood, elements that are useful or necessary in commercially feasible embodiments are often not depicted to provide a less obstructed view of the embodiments of the present disclosure.

### LISTING OF REFERENCE NUMERALS USED IN THE DRAWINGS

It will be appreciated that the names associated with the reference numerals as provided in the description do not match the names associated with the reference numerals as provided in the drawings. It is understood that the names used for the reference numerals in the description are to apply to the reference numerals used in the drawings, and that the names in the drawings are provided for convenience when referring between the description and/or the claims and the drawings.
100 localhost computer
102 localhost processor assembly
104 localhost memory, memory, or non-transitory processor-readable localhost memory
106 network interface assembly
108 display interface
110 user-interface unit
111 non-transitory localhost volatile memory
112 browser-assigned storage section
113 non-transitory processor-readable localhost storage
114 storage section
200 browser application
201 browser data
202 browser user interface
204 browser-scripting engine
206 browser runtime module
208 browser security module
250 operation
252 operation
254 operation
256 operation
258 operation
300 website-hosting server
302 processor assembly
304 memory assembly
306 network interface
308 user interface
310 display device
312 web-server software
314 web content database
316 web page
318 signaling link
319 signaling server process
320 web server software
350 operation
400 control program
401 access path
402 first processor operation
404 second processor operation
406 third processor operation
408 fourth processor operation
410 fifth processor operation
500 appliance
501 appliance software module
502 operation
503 appliance data
504 operation
600 network
700 remote client computer
701 optional remote client computer
800 non-transitory processor-readable memory

### DETAILED DESCRIPTION OF THE NON-LIMITING EMBODIMENT(S)

The following detailed description is merely exemplary and is not intended to limit the described embodiments or the application and uses of the described embodiments. As used, the word “exemplary” or “illustrative” means “serving as an example, instance, or illustration.” Any implementation described as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure. The scope of the invention is defined by the claims. For the description, the terms “upper,” “lower,” “left,” “rear,” “right,” “front,” “vertical,” “horizontal,” and derivatives thereof shall relate to the examples as oriented in the drawings. There is no intention to be bound by any expressed or implied theory in the preceding Technical Field, Background, Summary or the following detailed description. It is also to be understood that the devices and processes illustrated in the attached drawings, and described in the following specification, are exemplary embodiments (examples), aspects and/or concepts defined in the appended claims. Hence, dimensions and other physical characteristics relating to the embodiments disclosed are not to be considered as limiting, unless the claims expressly state otherwise. It is understood that the phrase “at least one” is equivalent to “a”. The aspects (examples, alterations, modifications, options, variations, embodiments and any equivalent thereof) are described regarding the drawings. It should be understood that the invention is limited to the subject matter provided by the claims, and that the invention is not limited to the particular aspects depicted and described.

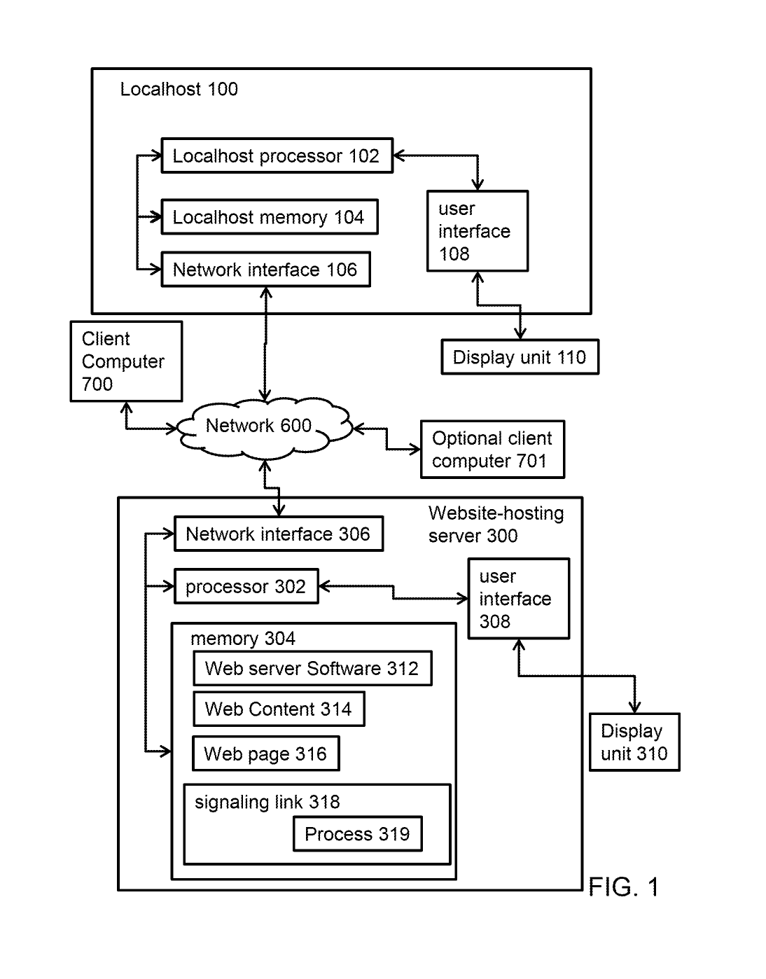

FIG. 1 depicts a schematic view of an embodiment of a localhost computer 100, a website-hosting server 300, a remote client computer 700 and a network 600.

Referring to the embodiment as depicted in FIG. 1, the localhost computer 100 is network connectable with the website-hosting server 300 via the network 600. The remote client computer 700 is network connectable with the website-hosting server 300 via the network 600. The localhost computer 100 and the remote client computer 700 interact with each other (indirectly) via the website-hosting server 300 over the network 600. The localhost computer 100 and the remote client computer 700 interact with each other through the website (that is, the web page 316 stored in the website-hosting server 300) for setup and control and via peer-to-peer interaction (e.g. for a video streaming operation, etc.).

More specifically, it is understood that the remote client computer 700 and the localhost computer 100 do not interact via a webpage, rather the remote client computer 700 and the localhost computer 100 interact via a separate signaling server which is defined (e.g. addressed or opened) within the web page 316 via JAVASCRIPT (TRADEMARK) programming code. The signaling server function is not part of the web page, rather the web page, in essence, plugs into the signaling server that is a distinct web site function on the same or a different web site.

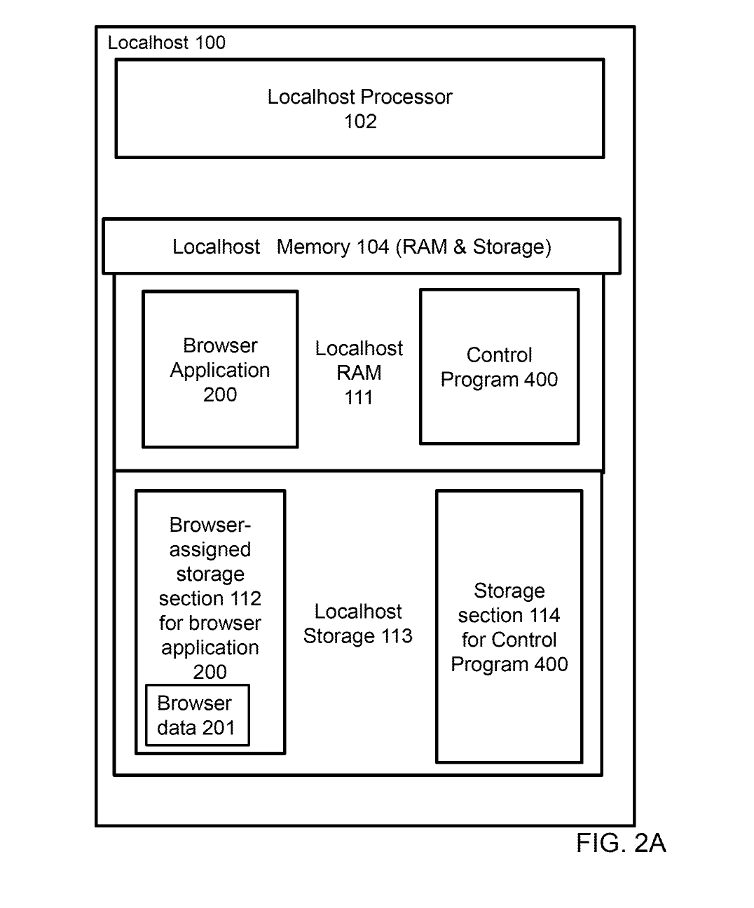

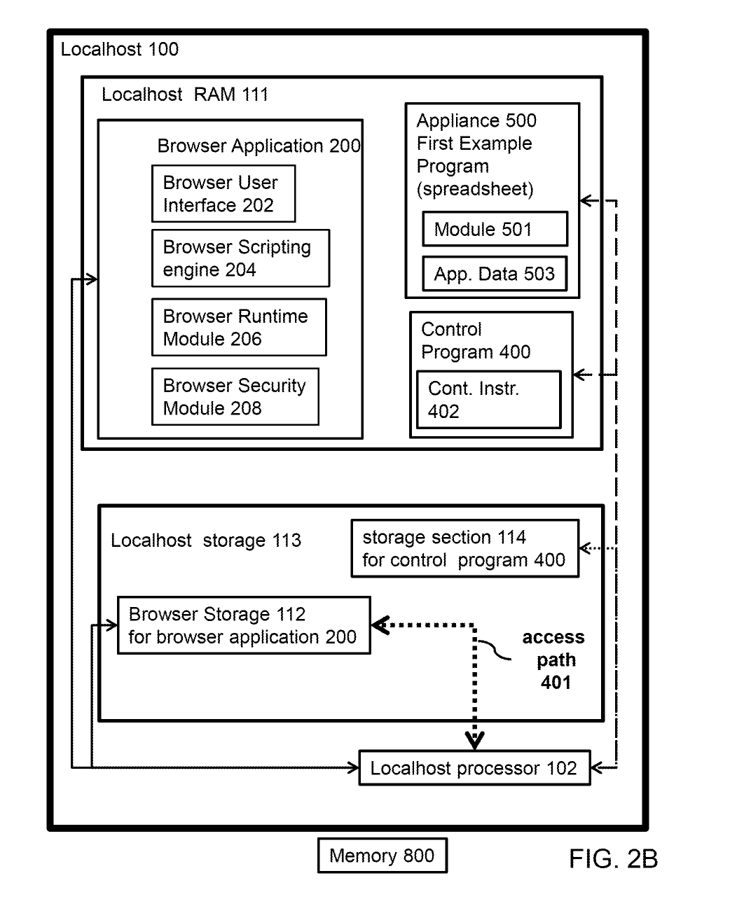

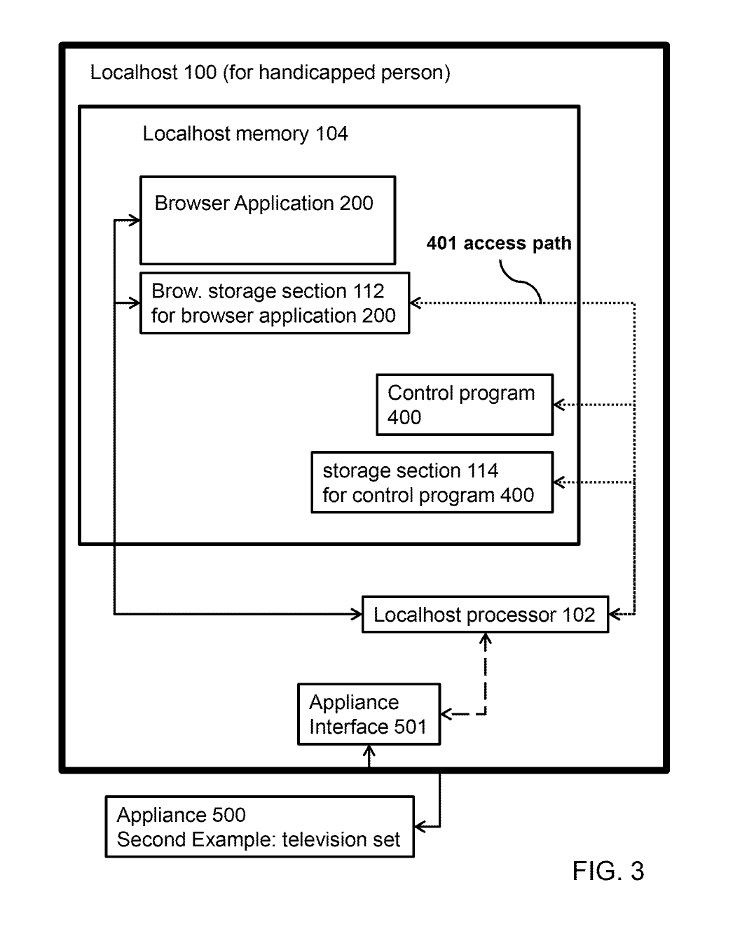

The website-hosting server 300 is an intermediary communications device. The localhost computer 100 and the remote client computer 700 do not interact with each other directly via the network 600 (except when in peer-to-peer communication). This is true for control flow such as the command from the remote client computer 700 to the localhost computer 100, wherein a request is made for the localhost computer 100 to interact with an appliance 500, that is depicted in FIG. 2B (such as, turning ON or powering ON a television, etc.); however, in an application such as WebRTC Video communication, the simultaneous video stream goes direct (peer-to-peer) between the remote client computer 700 and the localhost computer 100, and the scope of the operation of a control program 400 (as depicted in FIG. 2B and FIG. 3) does not relate to the interaction or management of the peer-to-peer stream (that is, the direct interaction between the remote client computer 700 to the localhost computer 100). It will be appreciated that the control program 400 is not part of a web browser application (the control program 400 is not included in a web browser application).

The localhost computer 100 may be configured for use by a user that is not technically savvy, not able to expertly manage the localhost computer 100, etc. For instance, the user of the localhost computer 100 may be a senior citizen, a handicapped person, a person having relatively little computer operation skills and/or knowledge, etc., and any equivalent thereof.

In accordance with an embodiment, the localhost computer 100 is configured to operate an interactive program configured to exchange information (data) between the user of the localhost computer 100 and the user of the remote client computer 700 via the website-hosting server 300 (over the network 600).

It is understood that the signaling process is part of the general function of a web hosting server in the WebRTC example, and may be included as part of the signaling link 318.

An embodiment of the interactive program may include a WebRTC video chat software program configured to exchange or facilitate a video and audio chat (discussion) between the user of the localhost computer 100 and the user of the remote client computer 700 via the website-hosting server 300 (over the network 600).

Referring to the embodiment as depicted in FIG. 1, the localhost computer 100 includes (and is not limited to) a localhost processor assembly 102, a non-transitory processor-readable localhost memory 104, a network interface assembly 106 and a display interface 108. The localhost processor assembly 102 is operatively coupled to the non-transitory processor-readable localhost memory 104 (also referred to, from time to time, as the localhost memory 104), the network interface assembly 106 and the display interface 108. A non-transitory processor-readable localhost volatile memory 111 (as depicted in FIG. 2A) may include Random Access Memory, volatile memory, and any type of memory. The non-transitory processor-readable localhost volatile memory 111 is (A) a portion of the non-transitory processor-readable localhost memory 104, and (B) configured to tangibly store processor-executable instructions configured to be readable by the localhost processor assembly 102. This is done in such a way that the processor-executable instructions urge the localhost processor assembly 102 to execute or perform operations (such as, a read operation, a write operation, a computing operation, etc.). The non-transitory processor-readable localhost volatile memory 111 may be referred to as the non-transitory localhost volatile memory 111.

The network interface assembly 106 is configured to be operatively interfaced with and connectable to the network 600 (such as, the Internet, etc.). The display interface 108 is configured to be operatively connected to a user-interface unit 110 (and any other user interface devices, such as a keyboard, mouse, etc.).

The definition of the localhost computer 100 (also called the localhost client computer) is as follows: the term “localhost” is a hostname that means “this computer” (in a computer networking structure). The term “localhost” refers to the local computer that a program is running on (the computer executes the program). For example, if a web browser (a program) is operated on a computer, the computer is considered to be the localhost (for the program). The term “localhost” is an accepted industry term for defining the specific local computer “client”.

Referring to the embodiment as depicted in FIG. 1, the website-hosting server 300 includes (and is not limited to) a processor assembly 302, a memory assembly 304, a network interface 306 and a user interface 308. The processor assembly 302 is configured to be operatively connected to the memory assembly 304, the network interface 306 and the user interface 308. The network interface 306 is configured to be operatively connected to the network 600. The user interface 308 is configured to be connected to a display device 310 (if so desired). It will be appreciated that the display device 310 and the user interface 308 are not typically used (or provided) with the website-hosting server 300, and that the display device 310 is used mostly for maintenance of the website-hosting server 300. The memory assembly 304 is configured to tangibly store software (applications) to be executed by the processor assembly 302 of the website-hosting server 300, such as (and not limited to) web-server software 312, a web content database 314, a web page 316 and a signaling link 318.

It will be appreciated that this may be expanded to a signaling server and a link (as may be provided by the signaling link 318). The signaling link 318 includes a signaling server process 319. It will be appreciated that this is an example of WebRTC architecture and is known and therefore not described further.

The definition of the website-hosting server 300 is the combination of (A) a computer system (such as, a microcomputer, a mainframe, etc., and any equivalent thereof, in which size, capacity and resources determine the volume of users and traffic, attached storage whose size and quantity is balanced with the computer capacity and capability), (B) an operating system (e.g. the WINDOWS (TRADEMARK) operating system, the LINUX (TRADEMARK) operating system, etc., and any equivalent thereof), (C) web server software (e.g. the WINDOWS (TRADEMARK) server software, the APACHE (TRADEMARK) server software, etc., and any equivalent thereof) and (D) a network interface configured to operatively interface with a communications network (e.g. the Internet, a private network, etc., and any equivalent thereof). The website-hosting server 300 is configured to store (host) files that include web pages (e.g., HTML pages) that are requested by a client computer (such as, the remote client computer 700) via a request from the web browser of the client computer. Specifically, when the client computer “goes to a site”, the client computer enters a web address (URL, Uniform Resource Locator) into the web browser, and the web browser (A) translates the web address (that was entered) into a file-download request to the website-hosting server 300, and (B) displays or executes the associated file contents (e.g. an HTML page, JAVASCRIPT (TRADEMARK) code, the PHP code, etc.) on the localhost computer 100. A uniform resource locator (URL, also called a web address) is a reference to a resource that specifies the location of the resource on a computer network (communications network) and a mechanism for retrieving the resource. A URL is a specific type of uniform resource identifier (URI), although these terms may be used interchangeably.

Referring to the embodiment as depicted in FIG. 1, the remote client computer 700 represents a collection (such as, hundreds, thousands or millions, etc.) of client computers that are clients of a particular web site (at any given time). The remote client computer 700 refers to a computer that is attached to the website-hosting server 300, and the website-hosting server 300 communicates (talks) with the localhost computer 100 and the remote client computer 700.

An optional remote client computer 701 (one or more instances of an optional computer) is attached to the website-hosting server 300 via the network 600, and is also connected via the website-hosting server 300 to the localhost computer 100.

For the case where a video chat application is deployed in the localhost computer 100 and on the remote client computer 700, the optional remote client computer 701 (e.g., an additional participant in the chat) displays to a caller (that is, the user) a web page, which sets up the call to the localhost computer 100 using a JAVASCRIPT (TRADEMARK) code (software) in the web HTML page and the signaling link 318 (also called a web-server signaling server and a signaling link) between the optional remote client computer 701 and the localhost computer 100. The signaling link 318 may be established by the signaling server software, and does not necessarily have to reside on the same server that has the signaling link 318.

It will be appreciated that the server and link function may be combined in the signaling link 318, and it is understood that the signaling link 318 is configured to establish a communication link between the localhost computer 100, the remote client computer 700 and the optional remote client computer 701, and that the signaling link 318 may reside on the localhost computer 100 or and/or other server. The signaling server process has a unique IP (Internet Protocol) address, in any case.

For example, a signaling server service may be used by both the optional remote client computer 701 and the localhost computer 100 that is provided by, for instance, GOOGLE; however, the web page and the JAVASCRIPT (TRADEMARK) code presented on the localhost computer 100, the remote client computer 700 and the optional remote client computer 701 is served by the web-server software 312 while the video stream travels peer-to-peer (that is, the video stream is moved from the remote client computer 700 to the localhost computer 100). The JAVASCRIPT (TRADEMARK) code or language is an object-oriented computer programming language commonly used to create interactive effects within web browsers. The localhost computer 100 may be used by a handicapped person with the control program 400 substituting for actions a capable user would otherwise initiate. The localhost computer 100 is a client of the website-hosting server 300. Specifically, the browser application 200 (depicted in FIG. 2B) of the localhost computer 100 and the browser of the optional remote client computer 701 are both operatively connected to a web page 316 served by the website-hosting server 300. More specifically, the localhost computer 100 and the remote client computer 700, while connected to the same server for the presentation of their unique web page, have their own unique web page (that is, the localhost computer 100 has a “home” coded web page, and the remote client computer 700 has a “caller” coded web page). It will be appreciated that the localhost computer 100 and the remote client computer 700 do not both use the same web page.

The signaling server and signaling link 318 is required by the website-hosting server 300 (or managed by a different web server, if so desired). However, while the signaling server and the signaling link 318 are active throughout the call (necessitating the operation of a server (also called, a computer) that is operatively positioned in the middle), the actual audio and video data stream is exchanged on a peer-to-peer basis between the localhost computer 100 and the optional remote client computer 701. There are, in effect, two links: the web-server signaling server and the signaling link 318 served by a program that is operating (being executed) on the website-hosting server 300 and a direct peer-to-peer connection; both are used by the browser application 200 of the localhost computer 100 to manage the overall video visit call process. It will be appreciated that the above describes the existing technology (what is called WebRTC functionality). WebRTC (Web Real-Time Communication) is an API (application programming interface) definition drafted by the World Wide Web Consortium (W3C) that supports browser-to-browser applications for voice calling, video chat, and P2P (Peer-to-peer) file sharing without the need of either internal or external plugins. In computing, a plug-in (also called, an add-in, an addin, a plugin, an extension, an add-on or an addon) is a software component that adds a specific feature to an existing software application. When an application supports plug-ins, it enables customization. The common examples are the plug-ins used in web browsers to add new features such as search-engines, virus scanners, or the ability to utilize a new file type such as a new video format. Well-known browser plug-ins may include (and are not limited to) the FLASH (TRADEMARK) player manufactured by ADOBE, the QUICKTIME (TRADEMARK) player and the JAVA (TRADEMARK) plug-in that may launch a user-activated JAVA (TRADEMARK) applet on a web page to its execution on a local JAVA (TRADEMARK) virtual machine.

FIG. 2A and FIG. 2B depict schematic views of embodiments of the localhost computer 100 of FIG. 1 (in which the localhost computer 100 is provided with a control program 400).

Referring to the embodiment as depicted in FIG. 2A, the non-transitory processor-readable localhost memory 104 (sometimes referred to as the localhost memory 104) includes (A) a non-transitory localhost volatile memory 111 (such as, a Random Access Memory device or RAM device, volatile memory, and any equivalent thereof), and (B) a non-transitory processor-readable localhost storage 113, such as, non-volatile memory, disk storage, a SD (Secure Digital) memory device (card), USB (Universal Serial Bus) memory device, any type of memory, and any equivalent thereof.

A browser-assigned storage section 112 is contained in (is part of) the non-transitory processor-readable localhost storage 113 (and therefore, is a portion of the localhost memory 104). The browser-assigned storage section 112 is assigned for (to be used by) the browser application 200. The browser-assigned storage section 112 may be called browser sandboxed storage (i.e. a storage area assigned to the browser not intended to interfere with or be used by any other process) in which the browser application 200 may store browser data. It is understood that the browser application 200 is programmed (configured) to (A) access (either directly or indirectly) the browser data 201 stored in the browser-assigned storage section 112, and (B) not access any other part of the localhost memory 104 other than the browser-assigned storage section 112 (storage is understood to be memory). It is understood that any other part of the non-transitory processor-readable localhost storage 113 (other than the browser-assigned storage section 112) may be called the browser-excluded storage, and is not accessible by the browser application 200 (because the browser application 200 is programmed as such).

It will be appreciated that the format of the browser data 201 may change depending on the manner in which the browser data 201 is moved (transmitted), and that the data format of the browser data 201 is not relevant (data does have a format suitable for different purposes depending on the manner in which the data is transmitted, stored, etc.). It will be appreciated that the reading of the browser data 201 and the appliance data 503 may be analyzed (processed) by the localhost processor assembly 102 (in response to the localhost processor assembly 102 executing code of the control program 400), and if this reading operation results in a write operation to the appliance data 503 and/or to the browser data 201, the content and format of that written data may be different than the data that was read. For example, the browser data 201 may include data [E] that signifies the end of session, and the resulting write to the appliance data 503 to power OFF may be data [tx standby 0], which is the computer coding in accordance with CEC (Consumer Electronics Control) format and protocol (for controlling the operation of the appliance 500, such as a television). It will be appreciated that the exact form and content of data read from the browser data 201 and/or the appliance data 503, if used in a subsequent write operation after processing, may or may not be identical to the data read in the initial read operation (that is, a data transformation may occur). This is a function of the different process protocols and codes sent from (provided by) the browser data 201 and those codes that are readable by the appliance 500 (for example). It will be understood that the usage of the terms “the browser data 201” and/or “the appliance data 503” means that the read data may be recoded and/or reformatted when the data is written. It will be appreciated that the data read from the browser data 201 and/or the appliance data 503 may be processed and then either sent on (conveyed) in (A) an as-is state, (B) a state that is required in a reformatted manner that is consistent with the requirements of the receiving element (device or software), or (C) in a state in which the data may be simply used as a trigger for an event (in which case the processing function does not reformat but instead initiates a responsive action and the data read is not passed on).

The browser application 200 is configured to not urge the localhost processor assembly 102 to store the browser data 201 or receive browser data 201 into or out from the browser-excluded storage (contained in the non-transitory processor-readable localhost storage 113) other than the contents of the browser-assigned storage section 112 in anyway whatsoever; this arrangement ensures that the browser application 200 does not inadvertently overwrite or delete the data (contents) stored in the browser-excluded storage (contained in the non-transitory processor-readable localhost storage 113).

The browser-assigned storage section 112 is for use by the browser application 200. The control program 400 does not gain access to the volatile memory device (such as RAM memory) where the browser application 200 resides, rather the control program 400 is configured to gain access only to the browser-assigned storage section 112 that does not reside in the volatile memory device (RAM) but is stored in the browser-assigned storage section 112 provided by the operating system to the browser application 200.

In accordance with a first major embodiment (as depicted in FIG. 2A), there is provided the localhost computer 100 that is for use with the network 600 (as depicted in FIG. 1). The network 600 is network connectable (either directly or indirectly) with the website-hosting server 300 (as depicted in FIG. 1). The localhost computer 100 is also for use with (either directly or indirectly) an appliance 500, such as a television set (a hardware device), a software product (a spreadsheet program), etc., and any equivalent thereof.

The localhost computer 100 includes (and is not limited to) the localhost processor assembly 102 that is network connectable (either directly or indirectly) with the network 600. The non-transitory processor-readable localhost memory 104 is configured to operatively couple to the localhost processor assembly 102. The non-transitory processor-readable localhost memory 104 includes a non-transitory processor-readable localhost storage 113.

The non-transitory processor-readable localhost storage 113 tangibly embodies a browser-assigned storage section 112 configured to tangibly embody browser data 201 associated with the browser application 200.

The non-transitory localhost volatile memory 111 tangibly embodies the browser application 200 that is configured to urge the localhost processor assembly 102 to (A) access (either directly or indirectly) the browser data 201 tangibly embodied in the browser-assigned storage section 112, and (B) not access contents of the remainder of the non-transitory processor-readable localhost storage 113 beyond the browser-assigned storage section 112.

The non-transitory localhost volatile memory 111 also tangibly embodies a control program 400 including processor-executable instructions configured to urge the localhost processor assembly 102 to (A) access (either directly or indirectly, via an access path 401 as depicted in FIG. 2B and FIG. 3, for instance) the browser data 201 stored in the browser-assigned storage section 112, and (B) control (either directly or indirectly) the appliance 500. A type of control that is to be imposed upon the appliance 500, either directly or indirectly by the localhost processor assembly 102, depends on the contents of the browser data 201 that was accessed (either directly or indirectly) from the browser-assigned storage section 112.

Preferably, in accordance with a preferred embodiment, the localhost computer 100 is adapted such that the control program 400 further includes processor-executable instructions configured to urge the localhost processor assembly 102 to control (either directly or indirectly) and manage (either directly or indirectly) aspects of the appliance 500 for supporting interaction activity (either directly or indirectly) between the browser application 200, the appliance 500 and the localhost computer 100.

Preferably, in accordance with a preferred embodiment, the localhost computer 100 is further adapted such that the control program 400 further includes processor-executable instructions configured to urge the localhost processor assembly 102 to execute any one of a read operation, a write operation and a modify operation (either directly or indirectly) on the browser data 201 stored in the browser-assigned storage section 112.

In accordance with a second major embodiment, there is provided a computer-implemented method of operating the control program 400. The computer-implemented method to be executed by the localhost processor assembly 102 of the localhost computer 100 is configured to urge the localhost processor assembly 102 to perform operations including (and not limited to): (A) accessing (either directly or indirectly) the browser data 201 stored in the browser-assigned storage section 112, and (B) controlling (either directly or indirectly) the appliance 500 (in which a type of control to be imposed upon the appliance 500, either directly or indirectly by the localhost processor assembly 102, depends on the contents of the browser data 201 that was accessed from the browser-assigned storage section 112).

In the example of a video chat, the appliance 500 (e.g., a television) may be the primary output display, and is configured to be interactive (e.g. accept instructions and send status, etc.) with the website-hosting server 300 through the control program 400 (because the browser application 200 cannot directly interact with the appliance 500). The appliance 500 may be operatively connected (either directly or indirectly) to the localhost computer 100 by a physical device connection (e.g. an HDMI cable) or as separate or imbedded computer code or files. Any data flow to or from the appliance 500 to the network 600 is managed (either directly or indirectly) by the browser application 200 and/or by the control program 400.

Referring to FIG. 2B, it is appreciated that there may be a distinction between the volatile memory device (RAM) and the non-volatile memory device (the storage). Therefore, the localhost memory 104 may include a combination of a non-volatile memory device and/or a volatile memory device, and any equivalent thereof). In accordance with a specific embodiment, the localhost memory 104 has both a non-transitory localhost volatile memory 111 and a non-transitory processor-readable localhost storage 113. The non-transitory localhost volatile memory 111 contains the browser application 200 and the control program 400 and also possibly contains the appliance software module 501 (also called appliance software). For instance, the appliance software module 501 is contained in any one of the appliance 500, the control program 400 and as a standalone instance of the appliance software module 501 stored in the non-transitory localhost volatile memory 111, etc., and any equivalent thereof.

The non-transitory processor-readable localhost storage 113 contains the browser-assigned storage section 112 and the storage section 114 (that is usable by the control program 400). The appliance software module 501 (of the appliance 500) is a special case in that the appliance software module 501 may include a resident program stored in the separate non-transitory localhost volatile memory 111 (the appliance software module 501 is for interfacing and controlling the appliance 500). If the appliance software module 501 is not a resident program stored in the non-transitory localhost volatile memory 111, the appliance software module 501 may include code (executable software) that is included in (A) the control program 400 and/or (B) in the software resident in the memory (storage) of the appliance 500 (such as, a smart television, etc.).

Referring to the embodiment as depicted in FIG. 2B, the localhost computer 100 includes the non-transitory processor-readable localhost memory 104. The localhost processor assembly 102 is operatively coupled to the non-transitory processor-readable localhost memory 104 in such a way that the localhost processor assembly 102 may read (either directly or indirectly) information (data) stored in the non-transitory processor-readable localhost memory 104 and write (either directly or indirectly) information (data) to the non-transitory processor-readable localhost memory 104.

The non-transitory processor-readable localhost memory 104 tangibly stores software applications, such as (and not limited to) a browser application 200 in the non-transitory localhost volatile memory 111 (such as, the RAM portion of the localhost memory 104). The browser application 200 includes a browser user interface 202, a browser-scripting engine 204, a browser runtime module 206 and a browser security module 208.

In accordance with the embodiment as depicted in FIG. 2B, the non-transitory processor-readable localhost memory 104 tangibly stores an appliance 500, in which the appliance 500 includes a software application such as (and not limited to) a spreadsheet application program. It will be appreciated that FIG. 3 depicts another embodiment of the appliance 500.

The non-transitory processor-readable localhost memory 104 tangibly stores a control program 400 (a software application) in the non-transitory localhost volatile memory 111 such as the RAM portion of the localhost memory 104).

The non-transitory processor-readable localhost memory 104 includes a storage section 114. The storage section 114 is in the non-transitory processor-readable localhost storage 113 portion of the localhost memory 104 and is for use by the control program 400.

The localhost processor assembly 102 is configured to exchange (read and write) information with the browser application 200, the appliance 500, the control program 400, the browser-assigned storage section 112 and the storage section 114.

More specifically, the manner in which the localhost processor assembly 102 is configured to exchange information (such as, data) with both the browser-assigned storage section 112 and the storage section 114 is that the localhost processor assembly 102 is further configured to manage access (read and write operations) to the non-transitory processor-readable localhost memory 104 (also called, physical memory) of the localhost computer 100. Specifically, the localhost processor assembly 102 is configured to execute the read and/or write instructions provided by, or included with, the control program 400). Therefore, the localhost processor assembly 102 is configured to access the contents of the non-transitory processor-readable localhost memory 104 (specifically, the browser-assigned storage section 112 and the storage section 114) of the localhost computer 100 (regardless of whether the browser-assigned storage section 112 was formatted under the control of an application program, such as the browser application 200). The non-transitory processor-readable localhost memory 104 includes the browser-assigned storage section 112. The localhost processor assembly 102 has access to the contents of the browser-assigned storage section 112 regardless that the browser-assigned storage section 112 was formatted and under the control of the browser application 200. It will be appreciated that there may be many instances of protected memory sections in the non-transitory processor-readable localhost memory 104; for instance, the operating system software is loaded (stored) into its own protected memory section (of the non-transitory processor-readable localhost memory 104) that is controlled by the operating software system (this protected memory portion varies in size based on the specifics of the operating system software). The remaining memory (of the non-transitory processor-readable localhost memory 104) is available to all processes (executable by the localhost processor assembly 102) on the localhost computer 100. Both the browser application 200 and the control program 400 are configured to provide instructions directing the localhost processor assembly 102 to ask for, and receive, their own block (portion) of protected memory from the operating system software of the localhost computer 100. These protected portions of the non-transitory processor-readable localhost storage 113 are represented as the browser-assigned storage section 112 for the browser application 200, and the storage section 114 for the control program 400. The restriction imposed onto the browser application 200 is done in such a way that the browser application 200 has processor-executable instructions configured to: (A) only instruct the localhost processor assembly 102 to gain access only to the browser-assigned storage section 112 (for the purposes programmed into the browser application 200), and (B) not instruct the localhost processor assembly 102 to gain access to any other memory of the non-transitory processor-readable localhost memory 104 (access to this other section of memory is permitted by other purposes, such as by the software operating system, etc.). The restriction imposed onto the browser application 200 is managed by the browser application 200, which makes the restriction really only one way. Specifically, the browser application 200 is configured to: (A) only access (either directly or indirectly) the browser-assigned storage section 112, and (B) not access any other storage portions of the non-transitory processor-readable localhost storage 113 of the localhost memory 104 beyond the browser-assigned storage section 112. The other processes operating on the localhost computer 100 (such as, the control program 400) may be configured to access (either directly or indirectly, read from and/or write to) the browser-assigned storage section 112 as well as the storage section 114 or any other memory portions of the non-transitory processor-readable localhost memory 104). Advantageously, the control program 400 is configured to access the contents of the browser-assigned storage section 112 (designated for the exclusive use of the browser application 200) regardless that the browser application 200 is configured to only access (either directly or indirectly) the contents of the browser-assigned storage section 112.

The control program 400 has access (represented as an access path 401) to the browser-assigned storage section 112 via the localhost processor assembly 102. Specifically, the browser data 201 to be conveyed (either directly or indirectly) to the control program 400 is conveyed via an access path 401. For instance, the control program 400 is configured to include executable instructions (such as, existing program functions, SQLITE in the C++ computer programming language) that direct (urge) the localhost processor assembly 102 to read the database files stored (tangibly stored) in the browser-assigned storage section 112 (even though the browser-assigned storage section 112 is allocated for the private or exclusive access by the browser application 200). The control program 400 is configured to provide instructions directing the localhost processor assembly 102 to gain access (read/write access) by uniquely using existing database access functions (for instance, the functions may be provided in a native program, such as the C++ computer program, in this case, the control program 400). The essential element is that the control program 400 is configured to have data including the name, structure and location of the contents of the browser-assigned storage section 112 in order to achieve (be able to) access the contents of the browser-assigned storage section 112. The control program 400 includes knowledge of the local storage files content of the browser-assigned storage section 112. The manufacturers of the browser application 200 do not broadly publicize information regarding the local memory storage format (to be implemented in the browser-assigned storage section 112 of the localhost computer 100) for any particular instance of the browser application 200 (provided by MICROSOFT INC., for instance). It will be appreciated that the structure of the local memory storage format (for any particular instance of the browser application 200) is unique to and defined by the manufacturer of the browser application 200. Therefore, the control program 400 may use standard (known) operating system file management utilities to examine the configuration files of the browser application 200 (such as, the “.config/chromium/Default/Local Storage directory” in the CHROMIUM (TRADEMARK) browser application) to determine the name, location and format of the local storage files for any particular instance of the browser application 200. For example, for the case of the CHROMIUM (TRADEMARK) browser application, the database used by the “localStorage” function of the CHROMIUM browser application is within this directory, and is named to coincide with the URL (Uniform Resource Identifier) of the HTML (Hypertext Markup Language) page that created the associated database records. The name extension (such as, “.db”) further shows that the record is in the SQL format and so is accessible by SQL database software (such as, SQLite). This is well within the capability of someone skilled in the art. SQLite is an in-process (software) library that implements a self-contained, serverless, zero-configuration, transactional SQL database engine (the code for SQLite is in the public domain and is thus free for use for any purpose, commercial or private).

The protected or browser-assigned storage section 112 is intended for exclusive access and use by the browser application 200 (separated from any other process on the localhost computer 100).

The control program 400 is configured to extend communications with the browser application 200 that manages aspects of the video call, and to also interact with, manage, direct, command, instruct, etc., the appliance 500. The appliance 500 is an entity that exists external to the browser application 200 (the browser application 200 cannot directly intercommunicate with the appliance 500 because the manufacturers of the browser application 200 do not permit such operations).

Data is exchanged with the browser application 200 on one side via the browser-assigned storage section 112 and on the appliance side of the appliance 500 using whatever communication function(s) that are provided by the appliance 500.

For example, for the case where the appliance 500 includes a television set (as depicted in FIG. 3), the television set is operatively connected to the localhost computer 100. The communication function is facilitated by software in the television called HDMI-CEC. HDMI stands for High-Definition Multimedia Interface (a proprietary audio/video interface). CEC stands for Consumer Electronics Control (an HDMI feature). The control program 400 includes software-executable code or an existing adjunct interface program (e.g. CEC-client, which is a program provided by a company called PULSE-EIGHT based in the United Kingdom), which interacts with the internal HDMI-CEC software program of the television (that is, the appliance 500) to control the television.

It will be appreciated that the appliance 500 includes executable software either in a physical device (as depicted in the embodiment of FIG. 3) or executable software tangibly stored in a memory unit (as depicted in FIG. 2B), and the control program 400 is configured to interact with the appliance 500.

For the case where the interaction is with the processor-executable software (simply referred to as executable software) of a physical device (as depicted in the embodiment of FIG. 3), the control program 400 is configured to used the interaction to cause some action on or in the appliance 500.

For the case where the interaction is with executable software tangibly stored in memory (as depicted in FIG. 2B), the executable software of the appliance 500 is not associated with a physical device, and actions (processor operations) may be initiated but they are just not associated with a physical device (per se). For example, the appliance 500 may include software that sends (transmits) text messages. The control program 400 may interact with the software of the appliance 500 to send out messages (e.g. a system status, a notification of a pending video visit or usage statistics).

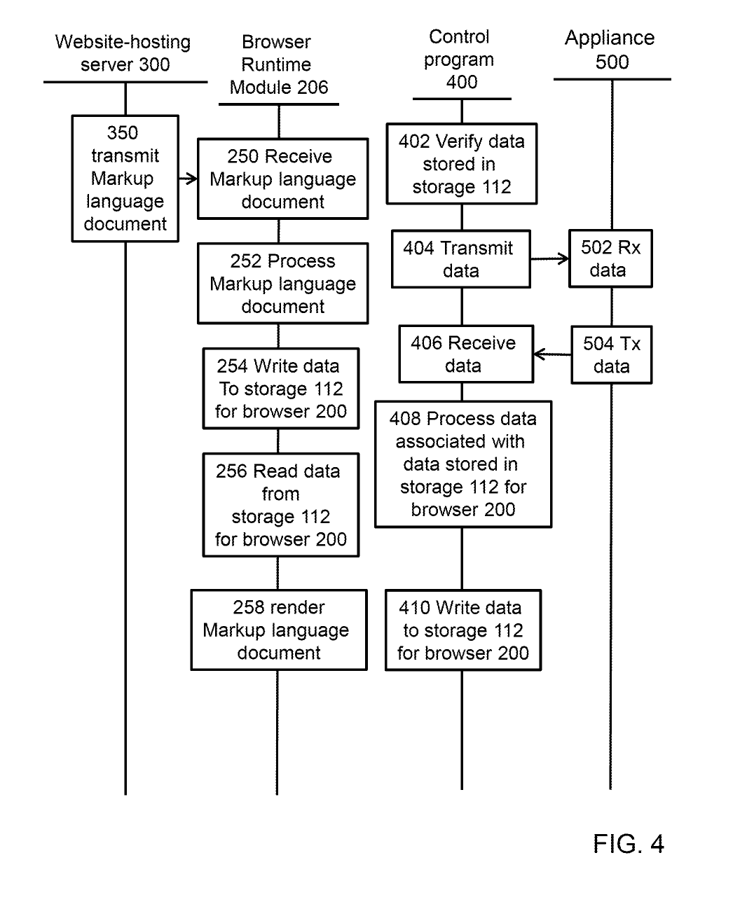

An application (such as, a video chat) uses the method (as depicted in FIG. 4) to achieve management of the localhost computer 100 and the appliance 500.

The method (as depicted in FIG. 4) is a general method of extending functionality between the browser application 200 and the appliance 500 both deployed in the localhost computer 100.

The appliance 500 may include software stored in the localhost memory 104 (as depicted in FIG. 2B) and/or hardware having software stored in the memory of the appliance 500 (as depicted in FIG. 3).

It is understood that a user (client) does not directly use the website-hosting server 300, rather the user interacts with the website-hosting server 300 through the browser and presented HTML page.

In accordance with a third major embodiment, there is provided a non-transitory processor-readable memory 800 (such as, a Secure Digital nonvolatile memory card, a flash memory drive, a compact disk, a portable memory device usable for the distribution of software, etc., and any equivalent thereof). The non-transitory processor-readable memory 800 tangibly embodies the control program 400 for use with the localhost computer 100.

FIG. 3 depicts a schematic view of an embodiment of the localhost computer 100 of FIG. 1, in which the localhost computer 100 is provided with a control program 400.

Referring to the embodiment as depicted in FIG. 3, the localhost processor assembly 102 is configured to interact with an appliance software module 501. The appliance software module 501 is configured to interact with the appliance 500. The appliance 500 is a standalone device separate from the localhost computer 100. The localhost processor assembly 102 is configured to interact with the appliance 500 via the appliance software module 501 (the appliance software module 501 may be called software interface, etc.).

In accordance with the embodiment as depicted in FIG. 2B, the non-transitory processor-readable localhost memory 104 tangibly stores an appliance 500, in which the appliance 500 includes a software module. FIG. 3 depicts an embodiment of the appliance 500 that is a hardware assembly, such as (and not limited to) a television.

FIG. 4 depicts a schematic view of an embodiment of a flow chart for the control program 400 of any one of FIG. 2B and FIG. 3. The flow chart may be used by a computer programmer (skilled in the art of computer programming) to generate (provide) processor-executable programmed code configured to urge the localhost processor assembly 102 (as depicted in FIG. 1) to execute various processor-related operations.

It will be appreciated that the localhost processor assembly 102 is configured to operate in response to reading the executable instructions provided by the website-hosting server 300, the browser runtime module 206 (of the browser application 200), the control program 400 and the appliance 500 (such as, any separate software process, such as the appliance software module 501, associated with the appliance 500).

The general overview of the operations depicted in FIG. 4 provides a description of the interaction among the website-hosting server 300, the browser runtime module 206, the control program 400 and the appliance 500.

Operation 350 (provided by the website-hosting server 300) includes transmitting (providing) an HTML document to the browser runtime module 206. The HTML document includes processor-executable instructions (such as, JAVASCRIPT (TRADEMARK) instructions, PHP instructions, etc.) configured to urge the localhost processor assembly 102 to display the HTML page and execute the associated program instructions in conjunction with the browser runtime module 206.

Operation 250 (provided by the browser runtime module 206) includes executable instructions configured to urge the localhost processor assembly 102 to verify full reception of the complete HTML document.

Operation 252 (provided by the browser runtime module 206) includes executable instructions configured to urge the localhost processor assembly 102 to (A) process the complete HTML document, and (B) present the HTML document via the user-interface unit 110 (as depicted in FIG. 1), and (C) manage an ongoing process for executing any HTML page programming associated with the presented HTML page (that is, the HTML document).

Operation 254 (provided by the browser runtime module 206) includes executable instructions configured to urge the localhost processor assembly 102 to write data to the browser-assigned storage section 112 for the browser application 200 in response to instructions from the presented HTML page's associated programming to write the requested data to the browser-assigned storage section 112 (used for access by the browser application 200). For example, the JAVASCRIPT (TRADEMARK) programming associated with the displayed HTML page may issue an instruction to write a date and time record to a file stored in the browser-assigned storage section 112 (for future reference). In this example, the JAVASCRIPT (TRADEMARK) program may use a command (such as, localStorage.TIME=“Jul. 30, 2015 10:45”) that causes a record named “TIME” to be written to the browser-assigned storage section 112, which may be read, modified or deleted at a later time (as may be required). Operation 254 is configured to provide a private storage area for the browser runtime module 206 to use as desired and that does not affect any other storage on the localhost computer 100 (such as, the storage section 114).

Operation 256 (provided by the browser runtime module 206) includes executable instructions configured to urge the localhost processor assembly 102 to read data from the browser-assigned storage section 112 (for use by the browser application 200); operation 256 is performed in response to instructions form the presented HTML page's associated programming to read requested data from the browser-assigned storage section 112. Further to the above example, the example may include the JAVASCRIPT (TRADEMARK) command [var time=localStorage.TIME], in which this command (instruction to the localhost processor assembly 102) causes (urges) the localhost processor assembly 102 to (A) read the TIME record from the browser-assigned storage section 112, and (B) store the value that was read in a program variable called [time].

Operation 258 (provided by the browser runtime module 206) includes executable instructions configured to urge the localhost processor assembly 102 to render a markup-language document. Operation 258 depicts the browser runtime function of rendering the HTML document on the user-interface unit 110 (as depicted in FIG. 1). It will be appreciated that while operation 258 is presented as a serial element in FIG. 4, operation 258 is an operation that may occur any time after the execution of operation 250 depending on user interaction with the HTML document or the actions of the HTML document's associated programming (that is, processor instructions). For instance, it is also possible that an HTML page (while performing various operations) does not, in fact render, a document on the user-interface unit 110, such as forward another HTML document (to the user via the user-interface unit 110) depending on some information read in (stored in) the browser-assigned storage section 112.

In accordance with an embodiment, the control program 400 further includes processor-executable instructions configured to urge the localhost processor assembly 102 to perform processor operations, including a first processor operation 402, a second processor operation 404, a third processor operation 406, a fourth processor operation 408, and a fifth processor operation 410.

The first processor operation 402 (provided by the control program 400) includes processor-executable instructions configured to urge the localhost processor assembly 102 to read and verify the browser data 201 stored in the browser-assigned storage section 112. More specifically, the first processor operation 402 further includes verifying that a correct file (A) exists in the browser-assigned storage section 112, and (B) is properly openable and accessible by a file management software. For instance, the first processor operation 402 includes verifying that the correct file (A) exists in the browser-assigned storage section 112 (for instance, the file name of [.config/chromium/Default/Local Storage/www.xxxx . . . db]) and, (B) may be properly opened and accessed (for reading, writing, modifying, deleting processor operations, etc.) by the file management software used in or by the control program 400 (such as, the file management software provided by an SQLITE (TRADEMARK) instruction).

The second processor operation 404 (provided by the control program 400) includes processor-executable instructions configured to urge the localhost processor assembly 102 to transmit the browser data 201 from the browser-assigned storage section 112 to the appliance 500 (such as, a television set). The data may include, for instance, an instruction transmittable to the appliance software module 501 (such as, the HDMI-CEC) (of the appliance 500) in which the appliance software module 501 is configured for controlling the appliance 500 (the appliance software module 501 operates internal to the appliance 500). The data (such as, the instruction) that is transmitted to the appliance software module 501 of the appliance 500 is formatted as may be required by the appliance software module 501 configured to control the appliance 500. For instance, HDMI-CEC is a control function that lets an audio/visual component control another (such as, when the components are connected via the HDMI cables). For example, inserting a disc into the DVD player would turn on the television set automatically or the A/V (audio/visual) receiver (if part of the system). The DVD disc is a type of compact disc configured to store large amounts of data, especially high-resolution audiovisual material.

The third processor operation 406 (provided by the control program 400) includes processor-executable instructions configured to urge the localhost processor assembly 102 to receive appliance data 503 that was transmitted from the appliance 500 (such as, from the appliance software module 501 that is configured to control the appliance 500, etc.). The third processor operation 406 and second processor operation 404 (while exemplified as communicating with the appliance software module 501 configured to control the appliance 500), may also include instructions for communicating with a software process (the appliance software module 501) that is not associated with the appliance 500 (a physical device, such as a television set); an example of the software process may include (and is not limited to) messaging software that is configured to send an external message and/or an internet message.

In accordance with a specific preferred embodiment, the appliance 500 includes a software process that is executable by the localhost processor assembly 102. The third processor operation 406 and the second processor operation 404 include instructions for communicating with the software process.

The fourth processor operation 408 (provided by the control program 400) includes executable instructions configured to urge the localhost processor assembly 102 to process the appliance data 503 that was received from the appliance 500 (such as, from the appliance software module 501 configured to control the appliance 500). More specifically, the fourth processor operation 408 includes processing the data that was read in by the first processor operation 402, in which the data was not used to perform the second processor operation 404 but the data instead was determined to be data for use by the control program 400 for other purposes. An example includes status or operational data that may be used by the control program 400 to evaluate the operational status of the browser runtime module 206 (such as, time active, running status) or data that the control program 400 may use as direction to perform a function or operation (such as, close files, reboot system, send files or information to the website-hosting server 300).

In accordance with a specific embodiment, the fourth processor operation 408 includes processing the browser data 201 that was read in by the first processor operation 402, in which the browser data 201 was not used to perform the second processor operation 404 but the browser data 201 instead was determined to be the browser data 201 for use by another purpose. For instance, the reading of the browser data 201 by the control program 400 has a technical benefit (advantage), which is that the control of the appliance 500 and the overall interaction between the control program 400 and the browser application 200 for process control is based on the browser application 200 placing data in the browser data 201 for control and management purposes. For example, for the case where the browser application 200 determines that the session is complete, the browser application 200 communicates data via the browser data 201 to the control program 400, so that the control program 400 closes files and reboots the localhost computer 100 (which the browser application 200 alone cannot do). Further, the control program 400 uses the browser data 201 to monitor the operational health of the browser application 200 via data passed in the browser data 201 and takes appropriate action in response. For example, for the case where the browser application 200 hangs or freezes (stops operating), the browser application 200 cannot fix itself, and the control program 400 will recognize the failure of the browser application 200 (to operate) and then the control program 400 provides instructions to the localhost processor assembly 102 to close all files and reboot the localhost computer 100, something the browser application 200 cannot do. This may be a critical function (operation) in the localhost computer 100 (a standalone system) that causes the localhost computer 100 to not operatively interact with a user (as in the case of a handicapped user who cannot interact directly with the localhost computer 100). While a capable user of the browser application 200 can see the browser application 200 fail and then restart the localhost computer 100, this is not possible for the case where the user is not engaged (skilled) enough to take this sort of action at will (for the case where the user is unskilled or unable to act accordingly to respond to error conditions or notifications and take appropriate action).

The fifth processor operation 410 (provided by the control program 400) includes processor-executable instructions configured to urge the localhost processor assembly 102 to write the appliance data 503 that was processed to the browser-assigned storage section 112. The browser-assigned storage section 112 is intended to be read or used by the browser application 200 (for the operation of the browser application 200). For example, the data may include temperature data of the localhost processor assembly 102 used by the browser application 200 to limit a session so that the temperature (of the localhost computer 100) does not exceed an upper operational limit of the localhost processor assembly 102. As a result of so informing the browser runtime module 206, the browser runtime module 206 may inform (via the user-interface unit 110 of FIG. 1) the user that the user should end the session (operation of the control program 400) as the operational temperature limit of the localhost processor assembly 102 is being approached.

Operation 502 (provided by the appliance 500) includes executable instructions configured to urge the appliance 500 to receive data from the control program 400 (via the localhost processor assembly 102).

Operation 504 (provided by the appliance 500) includes executable instructions configured to urge the appliance 500 to transmit data to the control program 400 (via the localhost processor assembly 102).

In accordance with an embodiment, the browser application 200 is configured to operatively interact with at least one or more servers, such as the website-hosting server 300 (as depicted in FIG. 1) and a signaling server (not depicted and is known). The interaction between the browser application 200 and the control program 400 remain essentially the same (with some minor changes possible) regardless of the number of servers that interact with the browser application 200. Preferably, the browser application 200 is configured to (A) interact with one server, (B) interact simultaneously with at least two or more servers and/or (C) interact with a secondary server to the website-hosting server 300, etc. For instance, the browser application 200 is configured to receive data in such a way that the browser application 200 (in use) facilitates interaction with an HTML page rendered by the browser runtime module 206.

WebRTC (Web Real-Time Communication) is an API definition drafted by the World Wide Web Consortium (W3C) that supports browser-to-browser applications for voice calling, video chat, and P2P file sharing without the need of either internal or external plugins.

In accordance with an embodiment, in a WebRTC session, the browser runtime module 206 is configured to interact with a physically different web server (specifically, with a signaling server) that is simultaneously (that is, within the same session) acting as an interface (for conveying signal messages) between one or multiple instances of the remote client computer 700 and the localhost computer 100. The resulting signal messages received by the localhost computer 100 may cause (urge) the browser runtime module 206 to (A) interact with the control program 400 for system control (for example, system control includes the shutdown and restart of the localhost computer 100), and/or (B) interact with the appliance 500 (such as, to instruct the appliance 500 to power off, etc.). The method of interaction between the browser runtime module 206 of the browser application 200 and the control program 400 (in such instances or examples) is the same as described previously (even though the source that causes the interaction may be the remote client computer 700 via the signaling server, such as the signaling server process 319). This is an example of the many possible alternative interactions that may be possible in the browser runtime module 206 that causes an interaction between the browser runtime module 206 and the control program 400. It will be appreciated that the interactions between the browser runtime module 206 (of the browser application 200) and the control program 400 utilize the same method and use of the browser-assigned storage section 112 as previously described (for other embodiments).

This written description uses examples to disclose the invention, including the best mode, and also to enable any person skilled in the art to make and use the invention. The patentable scope of the invention is defined by the claims, and may include other examples that occur to those skilled in the art. Such other examples are within the scope of the claims if they have structural elements that do not differ from the literal language of the claims, or if they include equivalent structural elements with insubstantial differences from the literal language of the claims.

It may be appreciated that the assemblies and modules described above may be connected with each other as required to perform desired functions and tasks within the scope of persons of skill in the art to make such combinations and permutations without having to describe each and every one in explicit terms. There is no particular assembly or component that may be superior to any of the equivalents available to the person skilled in the art. There is no particular mode of practicing the disclosed subject matter that is superior to others, so long as the functions may be performed. It is believed that all the crucial aspects of the disclosed subject matter have been provided in this document. It is understood that the scope of the present invention is limited to the scope provided by the independent claim(s), and it is also understood that the scope of the present invention is not limited to: (i) the dependent claims, (ii) the detailed description of the non-limiting embodiments, (iii) the summary, (iv) the abstract, and/or (v) the description provided outside of this document (that is, outside of the instant application as filed, as prosecuted, and/or as granted). It is understood, for this document, that the phrase “includes” is equivalent to the word “comprising.” The foregoing has outlined the non-limiting embodiments (examples). The description is made for particular non-limiting embodiments (examples). It is understood that the non-limiting embodiments are merely illustrative as examples.

What is claimed is:

1. A localhost computer for use with a network being network connectable with a website-hosting server, and for use with an appliance configured to be interactive with the website-hosting server, the localhost computer comprising:
a localhost processor assembly being network connectable with the network; and
a non-transitory processor-readable localhost memory being configured to operatively couple to the localhost processor assembly, and the non-transitory processor-readable localhost memory including:
a non-transitory processor-readable localhost storage tangibly embodying a browser-assigned storage section, and the browser-assigned storage section being configured to tangibly embody browser data associated with a browser application;
a non-transitory localhost volatile memory tangibly embodying the browser application being configured to urge the localhost processor assembly to (A) access the browser data tangibly embodied in the browser-assigned storage section, and (B) not access contents of a remainder of the non-transitory processor-readable localhost storage beyond the browser-assigned storage section; and
the non-transitory localhost volatile memory also tangibly embodying a control program including processor-executable instructions being configured to urge the localhost processor assembly to:
(A) access the browser data stored in the browser-assigned storage section; and
(B) control the appliance, in which a type of control to be imposed upon the appliance, by the localhost processor assembly, depends on the contents of the browser data that was accessed from the browser-assigned storage section.

2. The localhost computer of claim 1, wherein:
the control program further includes processor-executable instructions configured to urge the localhost processor assembly to control and manage aspects of the appliance for supporting interaction activity between the browser application, the appliance and the localhost computer.

3. The localhost computer of claim 1, wherein:
the control program further includes processor-executable instructions configured to urge the localhost processor assembly to execute any one of a read operation, a write operation and a modify operation on the browser data stored in the browser-assigned storage section.

4. The localhost computer of claim 1, wherein:
the control program further includes processor-executable instructions configured to urge the localhost processor assembly to perform processor operations, including:
a first processor operation including processor-executable instructions configured to urge the localhost processor assembly to read and verify the browser data stored in the browser-assigned storage section;
a second processor operation including processor-executable instructions configured to urge the localhost processor assembly to transmit the browser data from the browser-assigned storage section to the appliance;
a third processor operation including processor-executable instructions configured to urge the localhost processor assembly to receive appliance data that was transmitted from the appliance;
a fourth processor operation including processor-executable instructions configured to urge the localhost processor assembly to process the appliance data that was received from the appliance; and
a fifth processor operation including processor-executable instructions configured to urge the localhost processor assembly to write the appliance data that was processed to the browser-assigned storage section.

5. The localhost computer of claim 4, wherein:
the first processor operation further includes verifying that a correct file (A) exists in the browser-assigned storage section, and (B) is properly openable and accessible by a file management software.

6. The localhost computer of claim 2, wherein:
the browser data to be conveyed to the control program is conveyed via an access path.

7. The localhost computer of claim 6, wherein:
an appliance software module is contained in any one of the appliance, the control program and as a standalone instance of the appliance software module stored in the non-transitory localhost volatile memory.

8. The localhost computer of claim 4, wherein:
the appliance includes a software process being executable by the localhost processor assembly; and
the third processor operation and the second processor operation include instructions for communicating with the software process.

9. The localhost computer of claim 4, wherein:
the fourth processor operation includes:
processing the browser data that was read in by the first processor operation, in which the browser data was not used to perform the second processor operation but the browser data instead was determined to be the browser data for use by another purpose.

10. A non-transitory processor-readable memory tangibly embodying a control program for use with a localhost computer, and the localhost computer for use with a network being network connectable with a website-hosting server, and for use with an appliance configured to be interactive with the website-hosting server, and the localhost computer including a localhost processor assembly being network connectable with the network, and the localhost computer including a non-transitory processor-readable localhost memory being configured to operatively couple to the localhost processor assembly, and the non-transitory processor-readable localhost memory including a non-transitory processor-readable localhost storage tangibly embodying a browser-assigned storage section, and the browser-assigned storage section being configured to tangibly embody browser data associated with a browser application, and the non-transitory processor-readable localhost memory including a non-transitory localhost volatile memory tangibly embodying the browser application being configured to urge the localhost processor assembly to (A) access the browser data tangibly embodied in the browser-assigned storage section, and (B) not access contents of a remainder of the non-transitory processor-readable localhost storage beyond the browser-assigned storage section, and the control program including processor-executable instructions configured to urge the localhost processor assembly to perform processor operations, comprising:
(A) accessing the browser data stored in the browser-assigned storage section; and
(B) controlling the appliance, in which a type of control to be imposed upon the appliance, by the localhost processor assembly, depends on the contents of the browser data that was accessed from the browser-assigned storage section.

11. A computer-implemented method of operating a control program being executable on a localhost computer, and the localhost computer for use with a network being network connectable with a website-hosting server, and for use with an appliance configured to be interactive with the website-hosting server, and the localhost computer including a localhost processor assembly being network connectable with the network, and the localhost computer including a non-transitory processor-readable localhost memory being configured to operatively couple to the localhost processor assembly, and the non-transitory processor-readable localhost memory including a non-transitory processor-readable localhost storage tangibly embodying a browser-assigned storage section, and the browser-assigned storage section being configured to tangibly embody browser data associated with a browser application, and the non-transitory processor-readable localhost memory including a non-transitory localhost volatile memory tangibly embodying the browser application being configured to urge the localhost processor assembly to (A) access the browser data tangibly embodied in the browser-assigned storage section, and (B) not access contents of a remainder of the non-transitory processor-readable localhost storage beyond the browser-assigned storage section, and the computer-implemented method being executable by the localhost processor assembly of the localhost computer, and the computer-implemented method, associated with the control program, being configured to urge the localhost processor assembly to perform operations, comprising:
(A) accessing the browser data stored in the browser-assigned storage section; and
(B) controlling the appliance, in which a type of control to be imposed upon the appliance, by the localhost processor assembly, depends on the contents of the browser data that was accessed from the browser-assigned storage section.

12. The computer-implemented method of claim 11, further comprising:
controlling and managing aspects of the appliance for supporting interaction activity between the browser application, the appliance and the localhost computer.

13. The computer-implemented method of claim 11, further comprising:
executing any one of a read operation, a write operation and a modify operation on the browser data stored in the browser-assigned storage section.

14. The computer-implemented method of claim 11, further comprising:
urging the localhost processor assembly to read and verify the browser data stored in the browser-assigned storage section;
transmitting the browser data from the browser-assigned storage section to the appliance;
receiving appliance data that was transmitted from the appliance;
processing the appliance data that was received from the appliance; and
writing the appliance data that was processed to the browser-assigned storage section.

15. The computer-implemented method of claim 11, further comprising:
verifying that a correct file (A) exists in the browser-assigned storage section, and (B) is properly openable and accessible by a file management software.

16. The computer-implemented method of claim 11, further comprising:
conveying the browser data to the control program via an access path.

17. The computer-implemented method of claim 11, further comprising:
containing an appliance software module in any one of the appliance, the control program and as a standalone instance of the appliance software module stored in the non-transitory localhost volatile memory.

18. The computer-implemented method of claim 11, further comprising:
executing a software process of the appliance; and
communicating with the software process.

19. The computer-implemented method of claim 11, further comprising:
processing the browser data, in which the browser data was not used but the browser data instead was determined to be the browser data for use by another purpose.
